(19) United States
(12) Patent Application Publication
(10) Pub. No.: US 2011/0169711 A1
(43) Pub. Date: Jul. 14, 2011

(54) Antenna for cellular handset with user adjustable gain

(75) Inventors: Joseph A. Bobier, Sunrise, FL (US); Nadeem Khan, Sunrise, FL (US); Jorge Gil, Tamarac, FL (US); Ilya Lisak, Plantation, FL (US)

(73) Assignee: xG Technology, Inc., Sarasota, FL (US)

(21) Appl. No.: 12/930,302

(22) Filed: Jan. 3, 2011

Related U.S. Application Data
(60) Provisional application No. 61/335,794, filed on Jan. 12, 2010.

(51) Int. Cl. H01Q 3/06; H01Q 1/50

(52) U.S. Cl. 343/859; 343/882

(57) ABSTRACT

This invention addresses a flip antenna design for mobile devices operating in ISM 900 MHz band. More specifically the present invention addresses the need to change the gain of a transceiver antenna (for mobile devices) with the flip of the antenna without changing any other characteristics of the transceiver.

### CROSS-REFERENCE TO RELATED APPLICATION

The present application claims the benefit of previously filed co-pending Provisional Patent Application Ser. No. 61/335,794 filed Jan. 12, 2010.

### FIELD OF THE INVENTION

A flip antenna design for mobile devices operating in ISM 900 MHz band is disclosed. More specifically the present invention addresses the need to change the gain of a transceiver antenna (for mobile devices) with a flip of the antenna without changing any other characteristics of the transceiver.

### BACKGROUND OF THE INVENTION

The ISM 900 MHz band (in USA) spans from 902 MHz to 928 MHz. Products offered in this band by numerous manufacturers range from a simple application like a baby monitor or a garage door opener to more sophisticated products like a nationwide mobile VoIP solution. For devices using a time division duplex scheme there is a critical need to receive and transmit voice and data slots in uninterrupted fashion. The need also arises to increase or even decrease the power of the signal in a split second. The ability to decrease or increase the gain of transceiver antenna at a flip of the antenna is highly desirable and is addressed by the present invention.

An Antenna is a critical part of any wireless transceiver device. There are a number of different types of antennas each tuned for a specific frequency band and application. Antenna parameters such as radiation pattern, gain, physical size and realization techniques are dependent on specific applications. Mobile communication devices sometimes use multiband antennas (all integrated into one single antenna) that cover a variety of frequency bands. Gain, cost and size of the antenna are important factors when designing antennas for mobile transceiver devices. Realization techniques for such antennas varied (over a number of years) from simple wire type (fixed or telescopic) to more sophisticated chip antennas or printed circuit antennas with various assembly techniques ranging from simple printed circuit board mounted antennas to the more complicated flip mechanical assemblies. Also, dual gain antennas are known in the prior art such as U.S. Pat. No. 7,312,758 issued to Seybold. But these prior art antennas are very different from the antenna of this disclosure as these patents typically use two antenna elements with a sensor that adjusts the matching network. In the antenna of this disclosure a single antenna that is matched for both high gain and low gain is used so no sensor is needed to adjust matching.

A fixed antenna is, by definition, at the optimal length for its operating frequency. Fixed antennas, however, do not store compactly and hence the antenna is always vulnerable to damage. Telescopic antennas, on the other hand, are protected inside the transceiver device when not in use. Telescopic antennas, however, can be difficult to open and users are less likely to fully extend the antenna, adversely affecting antenna performance. Chip antennas are mounted on the printed circuit board and are housed in the same enclosure as the transceiver device. While this approach keeps the cost of the device down, the antenna performance suffers because of close proximity to the electronics of the transceiver device and other characteristics of the enclosure. The user's body also absorbs and reflects radio waves in patterns that are difficult to predict when the antenna is designed. Thus, an antenna designed for optimal performance on a given frequency may not perform optimally when actually used by a particular person.

Therefore, it is an object of this invention to provide a flip antenna that is not subject to bending or breaking, whether in use or stored.

It is a further object of this invention to provide an antenna that is tuned for the ISM 900 MHz band.

It is a further object of this invention to provide an antenna that can minimize interference caused by a human body.

It is a further object of this invention to vary the gain of the transceiver antenna by the flip of the antenna.

It is a further object of this invention to provide a low cost, printed circuit antenna that can be mass produced and require very few discrete parts saving assembly and production time.

### BRIEF SUMMARY OF THE INVENTION

This invention addresses a flip antenna design for mobile devices operating in the ISM 900 MHz band. More specifically the present invention addresses the need to change the gain of a transceiver antenna (for mobile devices) with a flip of the antenna without changing any other characteristics of the transceiver.

For a fuller understanding of the nature and objects of the invention, reference should be made to the following detailed description taken in connection with the accompanying drawings.

### DESCRIPTION OF THE DRAWINGS

For a fuller understanding of the nature and objects of the invention, reference should be made to the accompanying drawings, in which:

FIG. 1 is a diagram of a preferred embodiment antenna on a handset;

FIG. 2 is a diagram of a preferred embodiment antenna;

FIG. 3 is a graph showing antenna performance in High and Low gain mode in free space;

FIG. 4 is a graph showing the comparison in performance between commercial ½ wave length dipole antenna and present invention in free space;

FIG. 5 is a graph showing the comparison in performance between commercial ½ wave length dipole antenna and present invention under human loaded condition in horizontal polarization;

FIG. 6 is a graph showing the comparison in performance between commercial ½ wave length dipole antenna and present invention under human loaded condition in vertical polarization; and,

FIGS. 7a and 7b are graphs showing antenna performance in High and Low gain mode under human loaded condition.

### DETAILED DESCRIPTION OF THE INVENTION

The ISM 900 MHz band (in the USA) spans from 902 MHz to 928 MHz. Products offered in this band by numerous manufacturers range from a simple application like a baby monitor or a garage door opener to more sophisticated products like a nationwide mobile VoIP solution. For devices using time division duplex schemes, there is a critical need to receive and transmit voice and data slots in uninterrupted fashion. The need also arises to increase or even decrease the power of the signal in a split second. The ability to decrease or increase the gain of transceiver antenna with a flip of the antenna is highly desirable and is addressed by the present invention.

The invention described in this application has the advantage of only having one flip element instead of two elements as described in prior art patents. All required elements are incased in one housing only. The flip antenna is used in both transmit and receive modes.

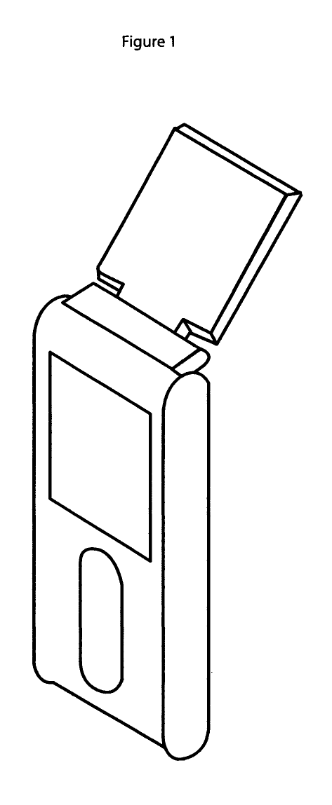

The flip antenna is designed to minimize user hand and head affects. When the flip antenna is opened the height of the antenna is increased and it is moved away form the close proximity to the electronics in the phone. Also the flip antenna in the open (high gain) position as shown in FIG. 1 can receive and transmit signal without getting too much interference from the human body. These factors decrease antenna loss and increase the antenna gain. The flip antenna also uses a balanced structure in a nonconventional way by not shorting unbalanced grounds together. In theory there will be locations at which linearity will be the most critical factor to receive un-impaired voice and data slots and at other times reference sensitivity will play a bigger role. A simple flip of the antenna will provide low (high linearity mode) or high (improved reference sensitivity) gain mode.

A diagram of the present invention (in high gain mode) installed on a mobile transceiver device is shown in FIG. 1. The construction of the present invention includes a flip housing (1) and radio back cover. In the flip housing (1) there are 4 critical elements that allow for the antenna's high gain. The antenna gain in high gain mode is better than or equal to commercially available half wave dipole whip antennas in this frequency band. The four elements of the preferred embodiment that lead to high gain are:
A near air dielectric (5) only 10 mils thick.
A critically designed ground strap (3) that connects unbalanced grounds on the antenna structure to unbalanced grounds on the transceiver board.
A high performance mini coaxial cable (2) connecting the unbalanced hot pin to the transceiver input.
Flip angle designed to minimize human head and hand loading on the antenna.

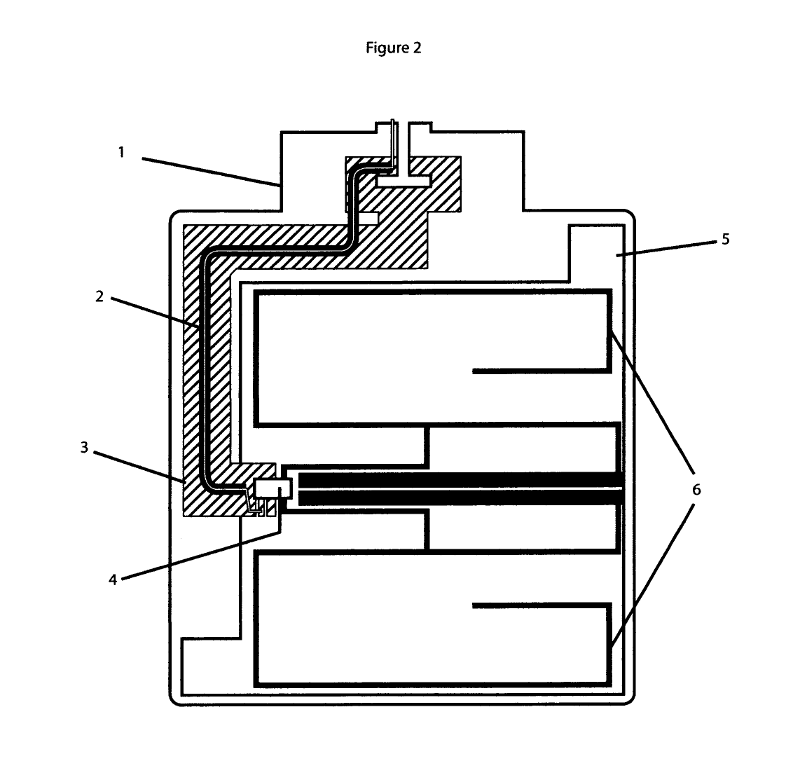

A picture showing the construction of the present invention is shown in FIG. 2. In the preferred embodiment a printed circuit board with a specific dielectric (5) is installed in a plastic housing (1). This printed circuit board also contains the antenna (6) and a Balun (4). A ground strap (3) is then placed between the Balun (4) ground and the antenna hinge. A thin coaxial cable (2) of 50 ohms impedance is then connected between the Balun (4) and the antenna hinge. The ground strap (3) and coaxial cable (2) pass through the antenna hinge and are connected to the transceiver circuit board (not shown in this figure). The plastic housing (1) is designed in such a way that it does not allow the ground strap (3) or the antenna (6) to move inside the plastic housing (1).

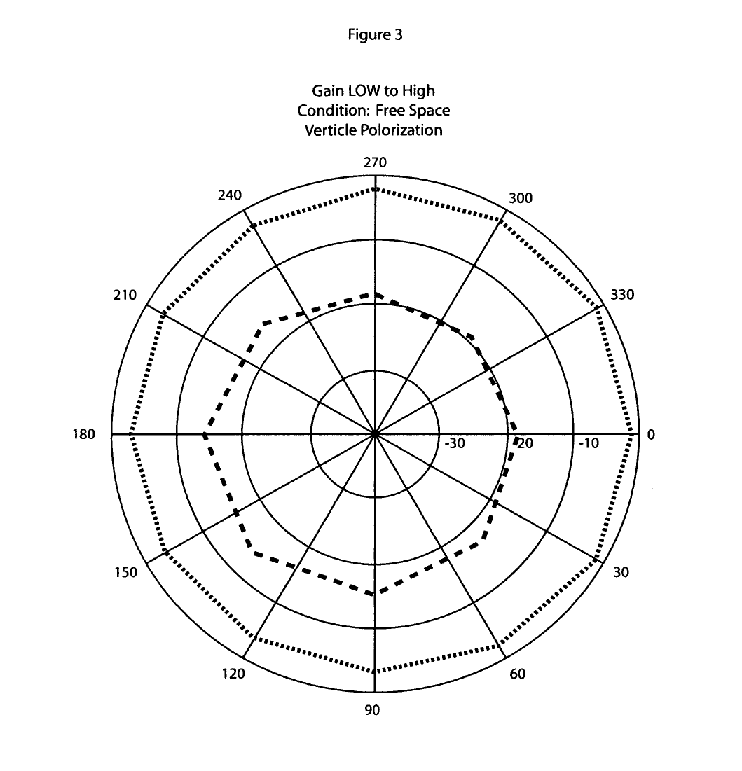

The following measurements were taken with the present invention and are shown in FIGS. 3 through 7:
Antenna gain in high and low gain mode in free space.
Comparison of present invention with ½ wave dipole antenna in free space.
Comparison of present invention with ½ wave dipole antenna under human loading in horizontal position.
Comparison of present invention with ½ wave dipole antenna under human loading in vertical position.
Radiation pattern of the present invention in horizontal and vertical polarization with high and low gain mode.

Radiation plots of the present invention in high and low gain mode in free space are shown in FIG. 3. From FIG. 3, it is clear that the present invention offers approximately a 15 dB average linear reduction in gain from low gain mode to high gain mode.

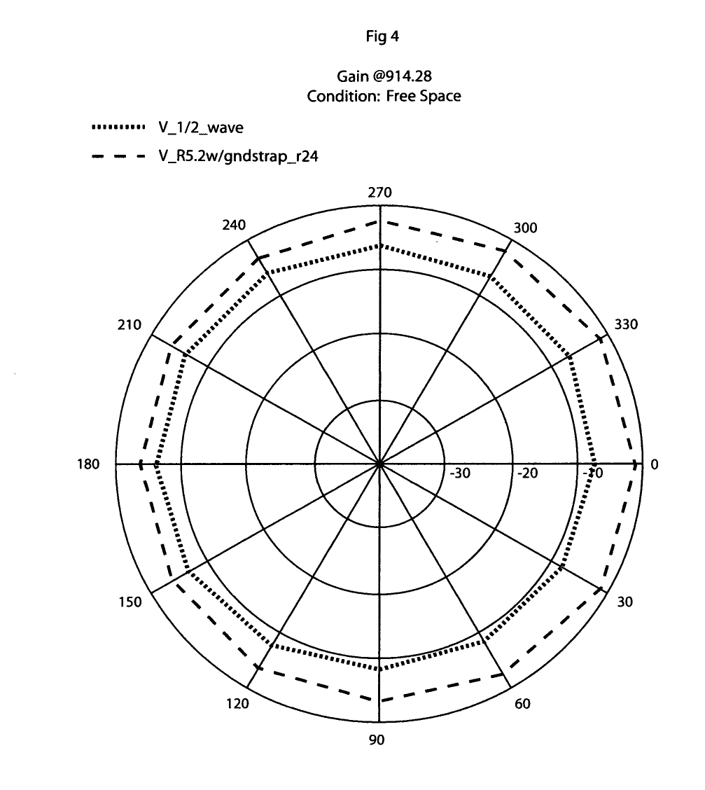

Radiation plots of the present invention and a commercial half wave dipole antenna are shown in FIG. 4. From FIG. 4 it is clear that the present invention offers a 2 to 6 dB improvement in free space gain compared to ½ wave dipole antennas.

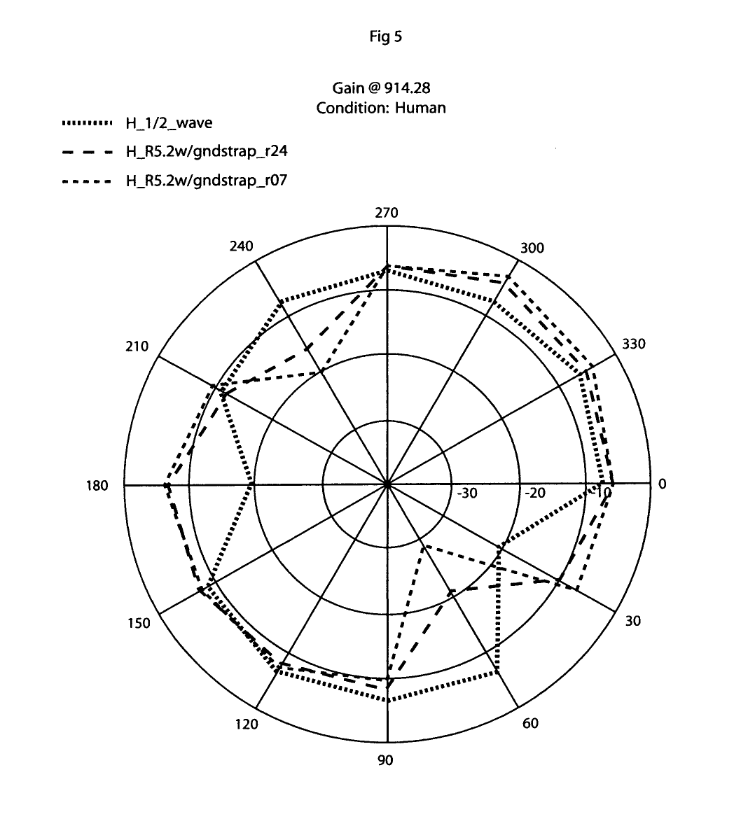

When loaded by human head and hand (Talk Position) the present invention closely matches the performance of a commercial off the shelf half wave antenna when measuring in the horizontal polarization. This is reflected in FIG. 5.

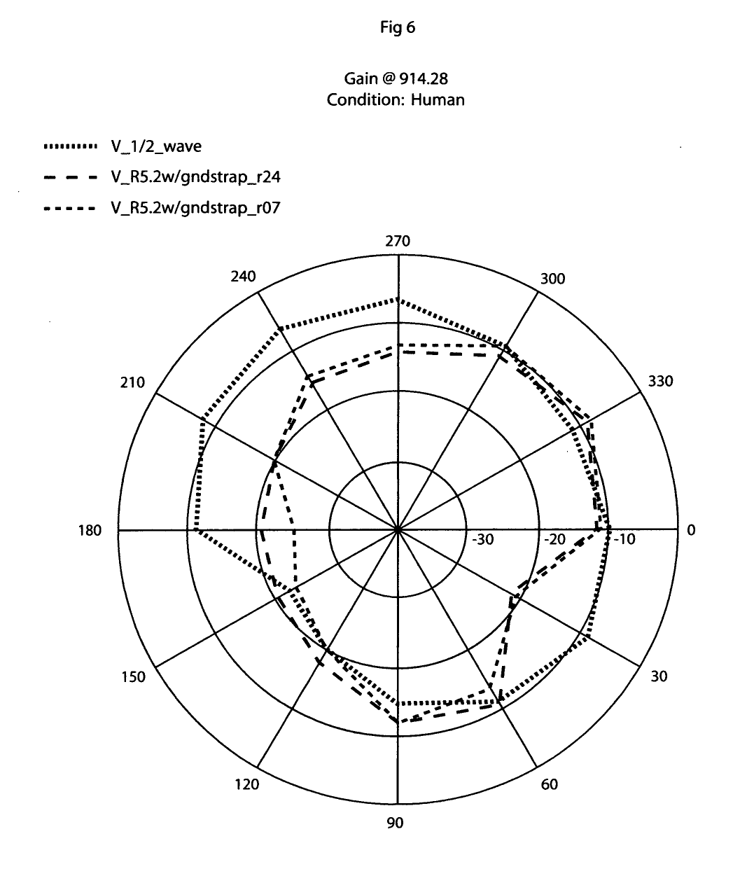

When loaded by human head and hand (Talk Position) the present invention closely matches the performance of a commercial off the shelf half wave antenna when measuring in the vertical polarization. This is reflected in FIG. 6.

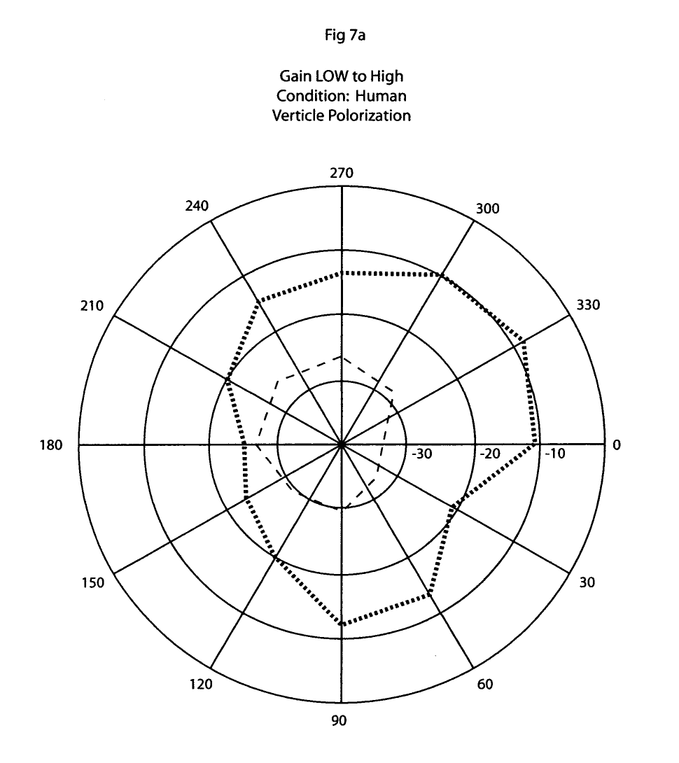

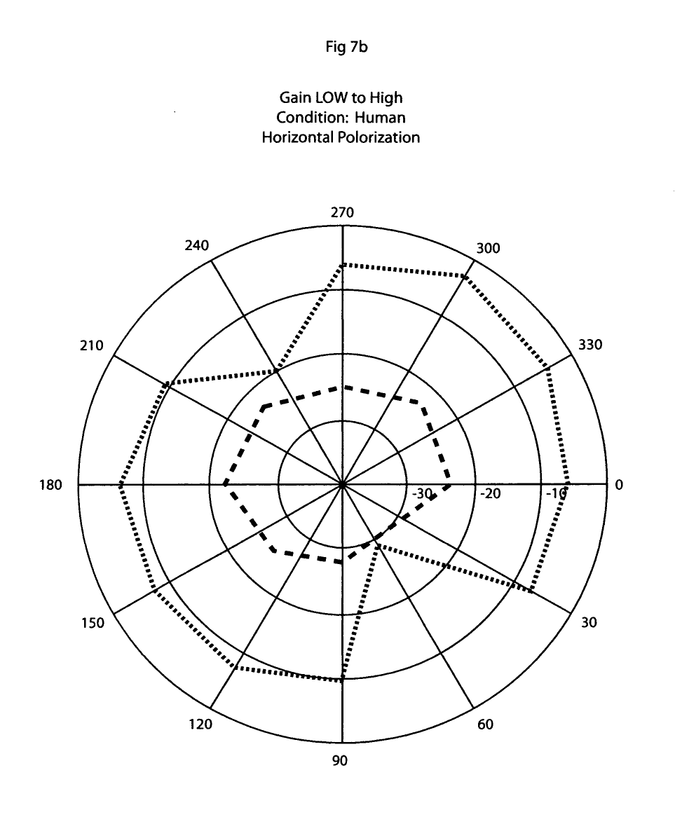

The radiation pattern of the present invention in horizontal and vertical polarization with high and low gain mode are shown in FIG. 7a and FIG. 7b:

A table comparing the performance of the present invention with a ½ wave dipole antenna is shown below:

| Measured | ½ Wave Dipole | Flip | | |
|---|---|---|---|---|
| Parameter | Antenna | Antenna | Polarization | Conditions |
| Maximum Gain | −6.58 | −8.4 | Vertical | Talk Position |
| Average Gain | −11.39 | −15 | Vertical | Talk Position |
| Maximum Gain | −6.17 | −3.5 | Horizontal | Talk Position |
| Average Gain | −9.39 | −9 | Horizontal | Talk Position |
| Maximum Gain | −3.11 | −0.76 | Vertical | Free Space |
| Average Gain | −4.74 | −2.3 | Vertical | Free Space |

High Low Gain Delta AVERAGE 16 dB
Gain units dBi

The present invention offers the following advantages:
Compact design.
High gain delta between high and low gain positions.
Decreased affect of human loading in high gain mode.
Offers similar Omni-directional pattern as that of a commercial 900 MHz
½ wave whip antenna.
All critical elements are within one flip housing.
⅓^{rd} the size of conventional off the shelf half wave whip antenna at 900 MHz.

Since certain changes may be made in the above described antenna for a cellular handset with user adjustable gain without departing from the scope of the invention herein involved it is intended that all matter contained in the description thereof, or shown in the accompanying figures, shall be interpreted as illustrative and not in a limiting sense.

What is claimed is:

1. A two position cell phone antenna that can be rotatably attached to a upper end of a cell phone wherein in closed mode the antenna will provide low (high linearity mode) gain or in open mode will provide high (improved reference sensitivity) gain comprising:
an antenna housing attached to a cell phone by a rotatable hinge connected to an upper end of the cell phone wherein said hinge allows said antenna housing to lie flat against a back of the cell phone or rotatably extend out from the back of the cell phone from 90 to 180 degrees;
said antenna housing containing an antenna pattern;
said antenna housing containing a near air dielectric surrounding said antenna pattern;
said antenna housing containing a balun electrically connected to said antenna pattern;
said antenna housing containing a ground strap electrically connecting said balun to unbalanced grounds on a transceiver board contained in said cell phone; and,
said antenna housing containing a high performance mini coaxial cable electrically connecting an unbalanced hot pin on said balun to an input on said transceiver board.

2. The two position cell phone antenna of claim 1 wherein said hinge allows said antenna to rotate to an set angle between 90 and 180 degrees designed to minimize human head and hand loading on said two position cell phone antenna.

3. The two position cell phone antenna of claim 1 wherein said near air dielectric is 9 to 11 mils thick.

4. The two position cell phone antenna of claim 1 wherein said mini coaxial cable is a 50 ohms impedance cable.
